(19) United States
(12) Patent Application Publication
(10) Pub. No.: US 2004/0045727 A1
(43) Pub. Date: Mar. 11, 2004

(54) Safe starting fluid hammer

(76) Inventors: Jeromy T. Allums, Lenoir City, TN (US); James E. Parson, White Pine, TN (US)

Correspondence Address: LUEDEKA, NEELY & GRAHAM, P.C., P O BOX 1871, KNOXVILLE, TN, 37901, US

(21) Appl. No.: 10/241,161

(22) Filed: Sep. 11, 2002

(51) Int. Cl. B25D 9/00

(52) U.S. Cl. 173/1; 173/2

(57) ABSTRACT

The present invention is directed toward a method and apparatus for improving the operating life of gas powered hammers such as are typically mounted on the hydraulic booms of construction equipment for breaking up rocks and/or debris. When a hammer of this type is fired without its tool coming into contact with a target object, the hammer body itself is often damaged by the internal impacts caused by the blank firing of the hammer. The present invention minimizes the damaging blank fires by determining the load on the hammer tool and preventing the hammer from firing if a no-load or low load condition exists. The load is determined based upon the pressure of the gas in the hammer gas supply or the position of the hammer tool with respect to the hammer body. In addition, a reserve gas supply and regulator are utilized to minimize the need to refill the hammer's gas supply and insure that the hammer operates at maximum power.

### FIELD OF THE INVENTION

The present invention relates generally to hammers that utilize pressurized fluid or gas to propel a hammer tool. More particularly, the present invention relates to an improved hydraulic/gas hammer that reduces or eliminates damage caused by blank firing of the hammer while insuring the gas pressure in the hammer remains at an optimum level.

### BACKGROUND OF THE INVENTION

Hydraulic or gas powered hammers, such as the E-series hammers produced by NPK Construction Equipment, Inc., are well known devices that are used to impart a striking force to a hammer-like tool or chisel. A hydraulic type of hammer generally utilizes a piston that is driven by hydraulic pressure. A gas or spring type hammering device typically uses hydraulic pressure to force a spring or gas in a piston into a compressed state. The compressed member is then released to impart the striking force to the hammer tool or chisel. While widely used, these powered hammers suffer from a number of drawbacks.

First, most hammers are designed to be placed on a hydraulic boom such as found on a backhoe and typically operated as by a foot pedal or an activation switch. Unfortunately, if the foot pedal or activation switch of a hammer using pressurized gas to propel the hammer tool is pressed prior to the tool being placed in a position to strike a target object, the force of the tool being pushed forward must be absorbed by the hammer itself. This is sometimes referred to as a blank or no-load fire. Blank firing can damage the hammer over time and is often the primary factor leading to the malfunction of the hammer. More particularly, the blank firing of a hammer can result in tie rod breakage.

Another problem with current gas powered hammers, or breakers as they are sometimes called, is that at least some of the pressurized gas used to propel the hammer tool forward tends to escape from the imperfectly sealed piston in which it is contained. Over time, this lost gas can cause a loss of gas pressure and a corresponding decrease in the striking force of the hammer tool. To overcome this problem, the pressurized gas in the hammer must be periodically replenished from a remote supply. This replenishing increases the down time of the hammer and the costs associated with operating the hammer. Thus, an improved gas/hydraulic powered hammer is needed.

### SUMMARY OF THE INVENTION

A preferred embodiment of the present invention is directed toward a hammer mounted on a hydraulic boom for imparting an impact force to an object by striking the object with a tool. The hammer includes a pressurized gas system that utilizes pressurized gas in conjunction with a piston to provide an impacting force to the tool in response to the pressurized gas system being activated by an activation switch. The pressurized gas system preferably has a hydraulic system that compresses a volume of pressurized gas in a piston such that the volume of pressurized gas imparts an impacting force to the tool through the piston when the hammer is activated by the activation switch. A loading means determines when a load has been placed on the tool. A disabling means disables the activation switch when the loading means determines that the load placed on the tool is below a predetermined level. In one embodiment, the loading means is a pressure sensor that measures a pressure of the pressurized gas and determines the load on the tool based upon the measured pressure of the pressurized gas. In an alternative embodiment, the loading means is a position sensor that determines the position of the tool in the hammer and the disabling means disables the activation switch based upon the sensed position of the tool in the hammer. A reserve pressurized gas container maintains a reserve supply of pressurized gas and a gas pressure regulator maintains the pressurized gas in the pressurized gas system at a substantially constant pressure by supplying pressurized gas from the reserve pressurized gas container to the pressurized gas system as needed. An alarm may be employed to indicate to an operator that the load placed on the tool is below the predetermined level.

The above described embodiment improves upon the prior art by preventing damaging blank fires from occurring. This reduces the costs associated with repairing the hammer as well as the time costs associated with the hammer being inoperable. In addition, automatically replenishing the pressurized gas in the hammer from a reserve gas supply eliminates the need to monitor and refill the pressurized gas system from a remote outside source. Thus, the above discussed embodiment reduces the costs associated with the use of a gas/hydraulic powered hammer.

Another embodiment of the present invention is directed toward a hammer mounted on a hydraulic boom. The hammer has a hydraulic system that produces a hydraulic pressure that is used to compress a gas contained in a pressurized gas system. A tool is positioned in the hammer such that the hydraulic system and the pressurized gas system work in conjunction to provide a striking force to the tool when an activation switch is activated to fire the hammer. A proper firing condition sensor determines whether the hammer is in an acceptable firing condition or an unacceptable firing condition. Preferably, the proper firing condition sensor senses the pressure of the pressurized gas and determines whether the hammer is in an acceptable or unacceptable firing condition based upon the sensed pressure. However, in an alternative embodiment, the proper firing condition sensor senses the position of the tool and determines whether or not the hammer is in an acceptable or unacceptable firing condition based upon the sensed position. A disabling system prevents the hammer from firing when the proper firing condition sensor determines the hammer is in an unacceptable firing condition. Thus, the hammer is only fired if the activation switch is enabled and the proper firing condition sensor indicates that the hammer is in an acceptable firing condition.

Yet another embodiment of the present invention is directed toward a method of controlling the operation of a powered hammer mounted on a hydraulic boom wherein the hammer uses a tool to impart a striking force to a target object. The method begins with the step of determining whether a load on the tool is such that firing of the hammer will result in a blank firing condition. The load on the tool may be determined by monitoring a pressure of a pressurized gas used to impart the striking force to the tool and indicating a blank firing condition if the pressure is below a predetermined level. Alternatively, the position of the tool may be sensed with a position sensor. The hammer is then prevented from firing if firing of the hammer will result in a blank firing condition. The hammer may be prevented from firing by disabling an activation switch that is used to fire the hammer. In addition, a gas pressure in a hammer gas supply used to fire the hammer is monitored and automatically replenished if the pressure falls below a predetermined level.

As previously discussed, eliminating or minimizing the occurrence of blank fires when operating a gas powered hammer extends the life of the hammer and reduces the need to replace the relatively expensive tie rod bolts. In fact, breakage of the tie rod bolts due to the tie rod bolts absorbing the impact force instead of the target object is all but eliminated by the present invention. Furthermore, reducing the down time of the hammer due to repairs reduces the incidental cost associated with the broken hammer. Therefore, the preferred embodiments of the present invention described above, and discussed in more detail below, offer a number of advantages over prior art hammers.

### BRIEF DESCRIPTION OF THE DRAWINGS

FIG. 1 is a block diagram of a preferred embodiment of the present invention;

FIGS. 2(a-c) are diagrams depicting proper and improper firing conditions for a gas powered hydraulic hammer;

FIG. 3 is a block diagram of another embodiment of the present invention; and

FIG. 4 is a flow chart of a preferred method of preventing blank fires in accordance with a preferred embodiment of the present invention.

### DETAILED DESCRIPTION

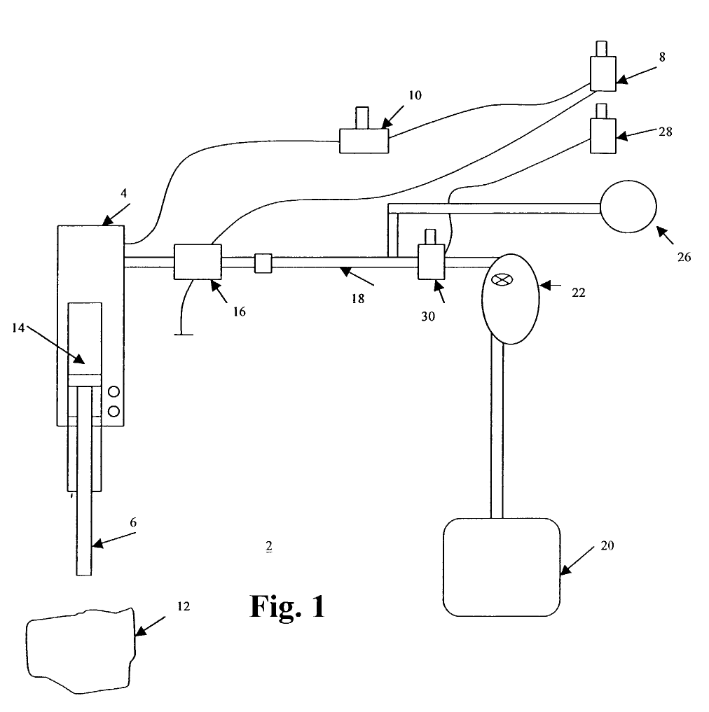

Referring now to FIG. 1, a block diagram of a preferred embodiment of a hammering system 2 of the present invention is shown. The hammering system 2 includes a hammer body 4 that has a hydraulic and gas powered system for providing an impacting force to a tool 6. The hydraulic and gas powered system preferably include a nitrogen gas filled piston 14 positioned inside the hammer body 4 that utilizes a hydraulic system to compress the nitrogen gas. When an activation switch 8 is pressed, a hammer valve 10 is opened that causes the hammer body 4 to release hydraulic pressure and thereby compress the gas in the piston 14. When the restraining hydraulic force is removed, the force stored in the pressurized nitrogen gas in the piston 14 in the hammer body 4 is imparted to the tool 6. Ideally, the tool 6 then strikes a target object 12, such as a rock, thereby causing the target object 12 to absorb the striking force from the tool 6 and, thus, break or shatter. However, if the tool 6 is positioned such that there is no target object 12 for the tool 6 to strike, the force imparted to the tool 6 by the gas filled piston 14 must be absorbed by the hammer body 4 itself or the tool 6 would be expelled from the hammer body 4 like a projectile.

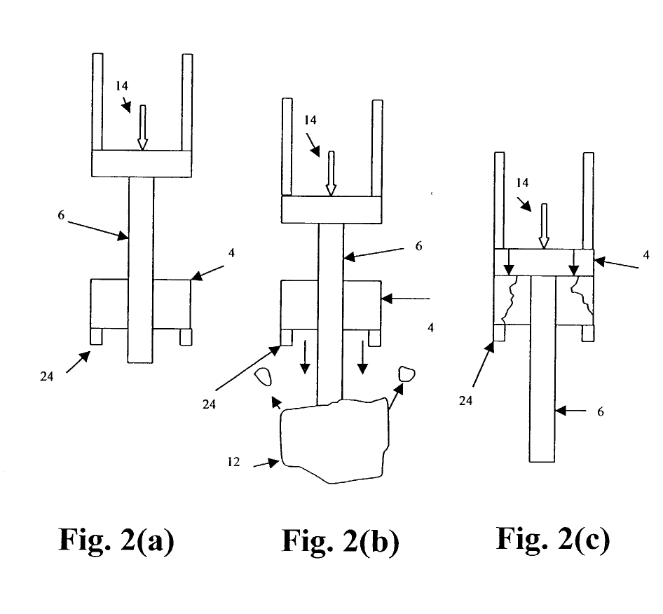

The situation where the hammering system 2 is fired without the tool 6 being in a proper position to contact a target object 12 before reaching the end of its range of motion is sometimes referred to as a blank fire and is shown in FIGS. 2(a-c). FIG. 2(a) shows the tool 6 in a loaded position with respect to the hammer body 4. When in the loaded position, the tool 6 is withdrawn at least partially into the hammer body 4. When properly fired, the tool 6 is propelled forward by the force of the gas filled piston 14 until the tool 6 strikes the target object 12 as shown in FIG. 2(b). In this case, the vast majority of the force applied to the tool 6 is absorbed by the target object 12.

However, when the hammer system 2 is fired without the tool 6 coming into contact with a target object 12 as shown in FIG. 2(c), the force applied to the tool 6 by the gas filled piston 14 must be absorbed by some structure in the hammer body 4 such as the tie rod bolts 24. Typically, an impact ring or plate is fastened with pins or bolts into a position on the hammer body 4 to absorb this blank firing force such that the damage to the hammer body 4 from the impact of the tool 6 is minimized. However, the large forces supplied to the tool 6 will, over time, damage the hammer body 4 and any impact absorbing structure positioned to protect the hammer body 4. This can significantly reduce the life span of the hammering system 2. Therefore, it is important when operating a prior art hydraulic/gas hammering system to avoid blank firing the hammer as much as possible.

Returning to FIG. 1, a pressure sensor 16 is provided on a hose 18 that provides nitrogen gas to the hammer body 4 from a source of pressurized gas. The pressure sensor 16 is connected to a three way switch 8 which is also connected to a hammer valve 10 that can be manipulated to activate the hammering system 2. The pressure sensor 16 and the three way switch 8 are preferably configured such that the hammer valve 10 will not be activated when the switch 8 is engaged unless the pressure sensed by the pressure sensor 16 is above a predetermined pressure level such as 25 pounds per square inch. If the tool 6 has been properly placed into contact with a target object prior to activating the hammering system 2, the pressure of the gas in the hose 18 will be elevated by the force of the tool 6 pressing against the target object 12 and, thus, compressing the nitrogen gas in the gas piston 14. This pressure can be monitored to determine whether or not to allow the hammer to fire.

While the pressure sensor of FIG. 1 is depicted as being located on the gas supply hose 18, it will be readily appreciated by those skilled in the art that the pressure may be sensed anywhere in the pressurized gas system from the pressure switch to the gas head of the hammer. Thus, in accordance with the present invention, a blank firing condition can be avoided by monitoring the pressure of the gas, such as the pressure inside the hose 18, and preventing the hammering system 4 from firing if the sensed gas pressure is below a certain level. In addition, the pressure can be continuously monitored during operation such that firing is automatically disabled if a blank firing situation is created by the hammer breaking through the target object. If the hammer 2 fails to fire when the switch 8 is activated, the hammer body 4 may be repositioned such that the tool 6 is in a proper firing position. An optional audible or visual alarm is preferably associated with the switch 8 to indicate to an operator of the hammering system 2 that a blank firing condition exists.

In an alternative embodiment, the hammer 2 may be configured to fire automatically whenever it is determined that the tool 6 of the hammer 2 is in a loaded position. A selector switch or button is preferably provided to allow an operator to select between operating in the automatic and manual firing modes.

FIG. 1 further illustrates a reserve pressurized gas container 20 that is provided to maintain the desired gas pressure in the gas piston 14 and hose 18. Whenever the gas pressure drops below the desired level, a regulator 22 will release additional gas from the reserve pressurized gas container 20. A cab gauge 26 is provided such that an operator of the device can monitor the gas pressure in the hammering system 2 and selectively add pressurized gas via a cab mounted switch 28 and corresponding gas valve 30.

The reserve gas container 20 improves the operation of the hammer 2 by eliminating the need to constantly replenish the gas supply in the hammer 2 from a remote supply as gas escapes from the edges of the piston 14 and any leaks in the hose 18. In addition, the constant replenishing of gas from the reserve container 20 provided by the regulator 22 insures that the impacting force delivered by the hammer 2 remains at a relatively constant and high level during use. Without such a reserve tank, the amount of force supplied by the hammer 2 decreases as gas escapes from the hammer 2. Thus, the reserve gas container 20 in conjunction with the blank firing inhibiting structure discussed above significantly improve the operation of the hammer 2.

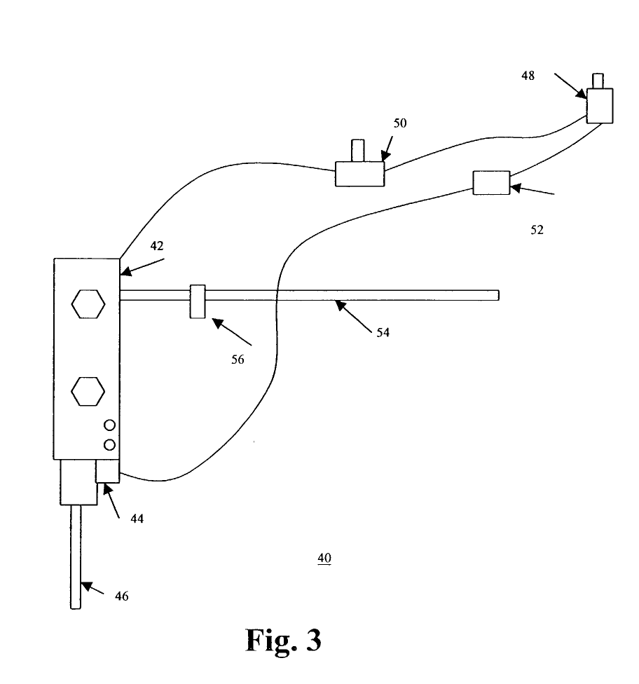

Referring now to FIG. 3, a hammering system 40 in accordance with another embodiment of the invention is shown. The hammering system 40 preferably includes a hammer body 42 that is supplied with pressurized gas through a pressure line 54 having a one-way valve 56. The system 40 further includes a tool position sensor 44 mounted on the hammer body 42 in a position to sense the position of a tool 46. If the tool 46 is pressed against a target object, the tool 46 will compress the gas in the gas piston in the hammer body 42 and retract into the hammer body 42. When an operator of the hammer 40 activates a switch 48 to open a hammer valve 50 and fire the hammer 40, the tool position sensor 44 detects the position of the tool 46 and sends a tool position signal to a microprocessor 52. The microprocessor 52 examines the signal to determine if the tool position indicates that the tool is a proper firing position.

For example, if the tool 46 is not pressed against a target object, the tool 46 will be in a fully extended position with regard to the hammer body 42. Similarly, if the tool 46 breaks through the target object during hammering, the tool 46 will also be fully extended. Conversely, if the tool 46 is firmly pressed against a target object, the tool 46 will be retracted into the hammer body 42 to some extent. If signals from the position sensor 44 indicate that the tool 46 is in a proper firing position, the microprocessor 52 allows the tool 46 to be fired. If the position sensor 44 indicates that the position of the tool 46 is such that a blank fire event may occur if the hammer 42 is fired, the microprocessor 52 disables the hammer 40 from firing through the use of switch 48. As previously, discussed an alarm may be provided to indicate to an operator of the hammer 40 that the tool 46 needs to be repositioned. Alternatively, the fact that the hammer 40 will not fire may be used to indicate to the operator that the tool 46 needs to be repositioned.

The embodiment of FIG. 3 substantially improves upon the prior art by minimizing the likelihood the hammer will fire without the tool coming into contact with a target object. This type of blank firing damages the hammer and increases the cost associated with maintaining the hammer. In addition, the embodiment eliminates the down time associated with repairing the hammer when it is damaged by blank fires. This is especially beneficial in the construction industry due to the rigid schedules and time sensitive nature of construction projects. Thus, the embodiment of FIG. 3 improves upon the prior art by decreasing the costs associated with the use of hydraulic/gas powered hammers.

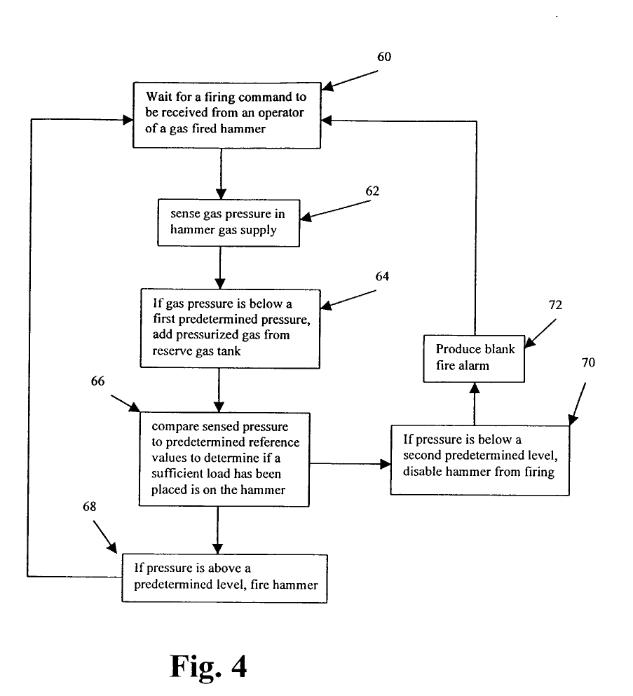

Referring now to FIG. 4, a preferred method for improving the reliability of a hydraulic and/or gas powered hammer is set forth. The method commences with the hammer waiting to receive a firing command from an operator of a gas fired hammer as shown in block 60. Once a fire command has been received from the operator, the method proceeds to block 62 wherein the gas pressure in the hammer gas supply is sensed. If the gas pressure is below a first predetermined pressure, pressurized gas is added to the main hammer supply from a reserve gas tank as shown in block 64. For example, if the minimum recommended pressure in the hammer gas supply for operating the hammer is 25 pounds per square inch and a pressure of 20 pounds per square inch is sensed, additional gas is added to the hammer supply from the reserve tank to increase the pressure to the desired 25 pounds per square inch. This prevents an operator of the device from repeatedly using low pressure fires that may be ineffective in imparting the required impact forces to the target object. In addition, it eliminates the need to stop work to periodically check and replenish the gas supply without really knowing if it is necessary to do so or not. In block 66, the sensed pressure is compared to a second predetermined reference value to determine if a sufficient load has been placed on the hammer to prevent blank firing damage to the hammer. For example, if the no load pressure of the hammer is 25 pounds per square inch, a pressure over 30 pounds per square inch indicates that a load has been placed on the tool of the hammer. If the pressure is above the second predetermined level, the hammer is fired in block 68 and the method returns to block 60 wherein the method waits to receive a firing command. If the pressure is below the second predetermined level, the method proceeds to block 70 wherein the hammer is disabled from firing. The method then proceeds to block 72 wherein a blank fire alarm is produced. The method then returns to block 60 where it waits to receive another firing command before repeating the method.

The above described preferred method reduces the need to physically monitor the gas pressure in the hammer to determine when it needs replenishing. In addition, disabling the hammer from firing when a blank firing condition is present reduces the likelihood the hammer itself will have to absorb the impact forces transferred to the tool of the hammer. Although the above method uses the gas pressure to determine when a blank firing condition may be present, a magnetic or laser based position sensor may be used to detect blank firing conditions by examining the tool's position with respect to the hammer body.

In view of the above explanation of the particular features of the present invention, it will be readily appreciated by one skilled in the art that the present invention can be usefully employed in a wide variety of embodiments. While certain embodiments have been disclosed and discussed above, the embodiments are intended to be exemplary only and not limiting of the present invention. The appropriate scope of the invention is defined by the claims set forth below.

1. A hammer for imparting an impact force to an object by striking the object with a tool, said hammer comprising:
a pressurized gas system for utilizing pressurized gas to provide an impacting force to the tool in response to the pressurized gas system being activated by an activation switch;
a load sensor for sensing when a load has been placed on the tool; and
a disabling switch operatively associated with the load sensor and the activation switch for disabling the activation switch when the load sensor senses that the load placed on the tool is below a predetermined level.

2. The hammer of claim 1 wherein the pressurized gas system further comprises a hydraulic system for compressing a volume of pressurized gas in a piston such that the volume of pressurized gas imparts an impacting force to the tool through the piston when the hammer is activated by the activation switch.

3. The hammer of claim 1 wherein the load sensor comprises a pressure sensor for measuring a pressure of the pressurized gas and determining the load on the tool based upon the measured pressure of the pressurized gas.

4. The hammer of claim 1 further comprising a reserve pressurized gas container for maintaining a reserve supply of pressurized gas and a gas pressure regulator for maintaining the pressurized gas in the pressurized gas system at a substantially constant pressure by supplying pressurized gas from the reserve pressurized gas container to the pressurized gas system as needed.

5. The hammer of claim 1 wherein the load sensor comprises a position sensor that determines the position of the tool in the hammer and wherein the disabling switch disables the activation switch based upon the sensed position of the tool in the hammer.

6. The hammer of claim 1 wherein the hammer is mounted on a hydraulic boom.

7. The hammer of claim 1 further comprising an alarm that indicates to an operator that the load placed on the tool is below a predetermined level.

8. A hammer mounted on a hydraulic boom, the hammer comprising:
a hydraulic system for producing a hydraulic pressure;
a pressurized gas system wherein the hydraulic pressure is used to compress a gas contained in the pressurized gas system;
a tool positioned in the hammer such that the hydraulic system and the pressurized gas system work in conjunction to provide a striking force to the tool when an activation switch is activated to fire the hammer;
a proper firing condition sensor for determining whether the hammer is in an acceptable firing condition or an unacceptable firing condition; and
a disabling system for preventing the hammer from firing when the proper firing condition sensor determines the hammer is in an unacceptable firing condition.

9. The hammer of claim 8 wherein the proper firing condition sensor senses the pressure of the pressurized gas and determines whether the hammer is in an acceptable or unacceptable firing condition based upon the sensed pressure.

10. The hammer of claim 8 wherein the proper firing condition sensor senses the position of the tool and determines whether or not the hammer is in an acceptable or unacceptable firing condition based upon the sensed position.

11. The hammer of claim 8 further comprising a gas resupply system for supplying pressurized gas to the pressurized gas supply when the pressure of the pressurized gas drops below a predetermined level.

12. The hammer of claim 8 wherein the hammer is only fired if the activation switch is enabled and the proper firing condition sensor indicates that the hammer is in an acceptable firing condition.

13. The hammer of claim 8 wherein the hammer is fired by pressing a foot pedal.

14. The hammer of claim 8 further comprising an alarm that indicates to an operator that the hammer is in an unacceptable firing condition.

15. A method of controlling the operation of a powered hammer mounted on a hydraulic boom wherein the hammer uses a tool to impart a striking force to a target object, the method comprising the steps of:
determining whether a load on the tool is such that firing of the hammer will result in a blank firing condition; and
preventing the hammer from firing if firing of the hammer will result in a blank firing condition.

16. The method of claim 15 wherein the step of determining the load on the tool comprises monitoring a pressure of a pressurized gas used to impart the striking force to the tool and indicating a blank firing condition if the pressure is below a predetermined level.

17. The method of claim 15 wherein the step of determining the load on the tool further comprises sensing the position of the tool with a position sensor.

18. The method of claim 15 wherein the hammer is fired by an activation switch and the step of preventing the hammer from firing further comprises disabling the activation switch.

19. The method of claim 15 further comprising the step of alerting an operator that firing of the hammer will result in a blank firing condition.

20. The method of claim 15 further comprising the step of monitoring a gas pressure in a hammer gas supply used to fire the hammer and automatically replenishing the hammer gas supply if the pressure falls below a predetermined level.

21. A hammer for imparting an impact force to an object by striking the object with a tool, said hammer comprising:
a pressurized gas system for utilizing pressurized gas to provide an impacting force to the tool in response to the pressurized gas system being activated by an activation switch;
loading means for determining when a load has been placed on the tool; and
disabling means for disabling the activation switch when the loading means determines that the load placed on the tool is below a predetermined level.
